(19) United States
(12) Patent Application Publication
(10) Pub. No.: US 2001/0009014 A1
(43) Pub. Date: Jul. 19, 2001

(54) Facilitating real-time, multi-point communications over the internet

(76) Inventors: James A. Savage III, San Jose, CA (US); Sophie Muller, Palo Alto, CA (US)

Correspondence Address: Cooley Godward LLP, Attn: Patent Group, Five Palo Alto Square, 3000 El Camino Real, Palo Alto, CA, 94306-2155, US

(21) Appl. No.: 09/777,392

(22) Filed: Feb. 5, 2001

Related U.S. Application Data
(62) Division of application No. 09/432,885, filed on Nov. 2, 1999.
Application No. 09/432,885 is a continuation-in-part of application No. 09/312,927, filed on May 17, 1999, now abandoned.
(60) Provisional application No. 60/128,037, filed on Apr. 6, 1999.

(51) Int. Cl. G06F 15/16

(52) U.S. Cl. 709/204; 709/227

(57) ABSTRACT

Methods and apparatus are described for facilitating a first conference between a plurality of clients on a network. A request to join a first conference is received from a first one of the plurality of clients via the network. In response to the request, it is determined whether the first conference is currently being facilitated on any of a plurality of media servers. Where the first conference is currently being facilitated on a first one of the plurality of media servers, the first client is dispatched to the first conference on the first media server. Where the first conference is not currently being facilitated on any of the plurality of media servers, creation of the first conference on a second one of the plurality of media servers is triggered, and the first client is dispatched to the first conference on the second media server.

### RELATED APPLICATION DATA

The present application is a continuation-in-part of U.S. Pat. application Ser. No. 09/312,927 for FACILITATING REAL-TIME, MULTI-POINT COMMUNICATIONS OVER THE INTERNET filed on May 17, 1999, which claims priority from U.S. Provisional application Ser. No. 60/128,037 for FACILITATING REAL-TIME, MULTI-POINT COMMUNICATIONS OVER THE INTERNET filed on Apr. 6, 1999, the entireties of which are incorporated herein by reference for all purposes.

### BACKGROUND OF THE INVENTION

The present invention relates to the transmission of data among entities on a network. More specifically, the present invention relates to real-time, multi-point communication among remote clients on the Internet.

Currently, a tremendous amount of capital and engineering expertise is being applied to the problem of providing real-time audio and video communication between and among remote locations over the Internet. However, at the present time there are virtually no adequate solutions for providing the kind of reliable, high quality communications to which consumers have become accustomed, i.e., communication over the dedicated connections of the public telephone infrastructure.

In fact, a significant portion of the problems associated with most Internet telephony applications is directly related to the fact that the link between the two communicating clients is not dedicated. That is, because the connections between the two clients are shared with a variety of other Internet traffic, there is, more often than not, a noticeable degradation in signal quality which results from the unpredictable and erratic traffic conditions of the Internet. The problem is exacerbated by the fact that, even with sophisticated data compression technology, audio and video data require a significant amount of bandwidth. Audio requires roughly 100 times the bandwidth required for text data, and the amount of bandwidth required for video is further orders of magnitude beyond audio.

Many Internet service providers (ISPs) and portals as well as entertainment and e-commerce web sites already provide a form of communication among remote clients which attempts to simulate real-time communication and have done so for some time. This form of communication is commonly referred to as a “chat room.” An ISP or portal provides an HTML link to a web page in which users may view text comments from other users and post text comments of their own in response. A chat room is typically implemented by dedicating a portion of a server owned and maintained by the ISP or portal to the handling and transmission of the text comments for all users currently viewing the corresponding page. Another similar form of communication provided by many ISPs and portals is referred to as “instant messaging” in which a user may send a text message to another user currently on-line with the same ISP.

The implementation of text messaging and chat rooms is relatively straightforward and reliable largely due to the fact that text messages require very little bandwidth and that there are no substantial latency issues related to the actual transmission of such messages. That is, due to the nature of text messages, traffic conditions do not result in delay or degradation which is noticeable from the user's perspective. Unfortunately, it is the nature of text communication which makes it so unsatisfactory a medium when compared with real-time audio and/or video communication. That is, communication by text is characterized by long delays in which the communicants must manually type their messages, and because of which messages often cross on the network. This often results in confusing exchanges with one or the other of the users eventually suggesting that the conversation recommence on a more reliable medium, e.g., the phone.

Moreover, the model according to which text communication is currently implemented is not applicable to audio or video communication because of the network traffic issues discussed above. Even if one were able to guarantee quality of service over the Internet, the bandwidth requirements of, for example, an audio chat room would not be amenable to the dedicated server approach currently employed. That is, a single text chat server can scale to thousands, even tens of thousands of users. However, because the bandwidth requirements of audio chat are roughly 100 times greater, a single server could only handle dozens (or at most a few hundred) users simultaneously. This is clearly inadequate given the user traffic of the large ISPs.

To handle its anticipated chat room traffic, a large ISP could employ multiple chat servers, each server being dedicated to running one or more specific chat rooms. However, this approach presents a variety of other problems. First, because an ISP has no way of predicting chat room traffic, it is likely that situations would frequently arise in which, due to the popularity of particular chat rooms, the capacity of the corresponding servers would be exceeded, resulting in dropped packets, the exclusion of new users, or even entire chat rooms going off-line. This could be alleviated by providing sufficient excess capacity on each server, but this would result in an unacceptable inefficiency in the use of server resources.

Another problem with such an approach is that the number of servers required to accommodate audio chat for the chat room traffic of a typical ISP would be quite large. While this may be seen as a great benefit for manufacturers of server hardware, it is not a desirable solution for the ISP from either an economic or administrative view point. Not only would it be expensive for each ISP to purchase and maintain such a large number of servers, it would also increase the odds that specific chat rooms would be inaccessible to users. That is, each time a particular server went down (e.g., for routine maintenance or as a result of a fault) the chat rooms on that server would be inaccessible to users until the server was rebooted or replaced. Understandably, this is undesirable from the ISP's point of view.

It is therefore desirable to provide high quality, real-time communication among a plurality of remote clients using a system which is scaleable to hundreds of thousands, even millions of users, and which dynamically allocates system resources to create and maintain communications among the clients.

### SUMMARY OF THE INVENTION

According to the present invention, a system is provided by which high-quality, real-time communication among a plurality of remote clients may be effected via the Internet. According to a specific embodiment of the invention, a conferencing system is provided which is scaleable to any number of simultaneous users and which may be used simultaneously by any number of ISPs, portals, and web sites to implement audio or video conferences through their sites. The system is based on a farm of servers, referred to herein as media servers, each of which runs one or more conferences in which any number of users may participate. Dynamic creation and allocation of conferences among the media servers are facilitated by a single dispatch server according to the available capacity reported by each. The dispatch and media servers (referred to collectively herein as the network operating center or NOC) sit directly on a high bandwidth, optical backbone by which remote clients may access the system.

The system's conferencing capacity is allocated according to agreements with customers (e.g., ISPs, portals, web auction sites, e-commerce sites, etc.) who, in turn, provide access to the system to their subscribers, i.e., the remote clients, via the ISPs' web sites. For example, the ISP may provide a web page which includes embedded graphical objects selection of which by a subscriber on a client machine facilitates participation of the subscriber in a conference. To access the system, a one-time download of a lightweight client, e.g., a browser plug-in, is required. Depending upon the configuration, when a user views a conference-enabled web page or when she clicks to join, the browser transmits the IP address of the dispatch server, the conference name, and an authentication code to the client. The client then contacts the dispatch server and, using the plug-in, transmits a request to join the conference. If the client is validated (by reference to the authentication code), the dispatch server determines whether the requested conference is currently being facilitated on any of the media servers. If the conference exists, the dispatch server dispatches the client to the corresponding media server. That is, the client is given the IP address of the media server, to which it transmits another join request. The media server then establishes a channel to the client and adds the client to the requested conference.

If, on the other hand, the requested conference does not exist, the dispatch server polls the media servers to determine which has most available capacity and triggers creation of the requested conference on that media server. The client is then dispatched to the media server in the manner described above. As clients leave a conference, the media server deletes them from the conference. When the last client is deleted, the conference is also deleted.

Because dynamic creation and allocation of conferences among the media servers are facilitated by the dispatch server according to media server capacity, the system's resources are efficiently used. Moreover, because the conferences are created dynamically, they may be recreated on another server in the event that, for example, the current server's capacity is exceeded. The shifting of a conference between servers is accomplished virtually transparently without the need for action by the participants.

According to a specific embodiment, the hardware and software of the present invention operate in virtually stateless manner. That is, once the dispatch server dispatches a client to a media server for participation in a conference, the dispatch server “forgets” about the existence of both the client and the conference. Likewise, once there are no clients left in a conference on a media server, the conference is released and the media server “forgets” the conference ever existed. Similarly, the client “knows” nothing about the structure and operation of the network operating center. It merely receives an address and a confirmation mechanism from the ISP and connects with the system accordingly. The result is an extremely reliable, robust, and flexible architecture which is adaptable to service any level of conference traffic.

Thus, the present invention provides methods and apparatus for facilitating communication between a plurality of clients on a network. A request from a first one of the plurality of clients to join a first conference is received with a dispatch server. The first client is dispatched to the first conference on a first one of a plurality of media servers associated with the dispatch server.

The present invention also provides a system for facilitating communication between a plurality of clients on a network. The system includes a plurality of media servers coupled to the network, each of which is for facilitating at least one conference. Each of the conferences corresponds to a subset of the plurality of clients. A dispatch server is coupled to the network for statelessly dispatching the clients to the conferences on the media servers. The dispatch server is operable in response to a request from a first one of the clients to join a first conference to either determine which of the media servers is facilitating the first conference, or trigger creation of the first conference on a first one of the media servers where the first conference is not currently being facilitated.

According to a specific embodiment of the invention, a dispatch server is provided for facilitating communication between a plurality of clients on a network using a plurality of media servers on the network. The dispatch server is based on a server object. A remote server service running on the server object provides access to the server object. A master service running on the server object communicates with and manages operation of the media servers in a stateless manner. The master service also statelessly dispatches the plurality of clients to conferences on the media servers.

According to another specific embodiment, a media server is provided for facilitating communication between a plurality of clients on a network in conjunction with a dispatch server on the network. The media server is based on a server object. A remote server service running on the server object provides access to the server object. A slave service running on the server object communicates with the dispatch server. A mesh service running on the server object dynamically provides virtual connections among the plurality of clients for transmission of data and thereby facilitates a conference including the plurality of clients. The virtual connections are dynamically created using a plurality of connection objects. A connect service running on the server object configures the connection objects in the mesh service to provide the virtual connections.

According to yet another specific embodiment, the present invention provides methods and apparatus for facilitating a first conference between a plurality of clients on a network. A request to join a first conference is received from a first one of the plurality of clients via the network. In response to the request, it is determined whether the first conference is currently being facilitated on any of a plurality of media servers. Where the first conference is currently being facilitated on a first one of the plurality of media servers, the first client is statelessly dispatched to the first conference on the first media server. Where the first conference is not currently being facilitated on any of the plurality of media servers, creation of the first conference is triggered on a second one of the plurality of media servers and the first client is statelessly dispatched to the first conference on the second media server.

A mesh service is also described herein for running on a media server, the media server being for facilitating communication among a plurality of clients. The mesh service comprises a plurality of instances of a connection object class. The connection object class comprises an input method for subscribing to an output of a first connection object and receiving data units therefrom, an output method for transmitting the data units to a second connection object subscribing to the output method, and a clock method for moving the data units from the input method to the output method. The plurality of instances of the connection object class are dynamically configured to provide virtual connections among the plurality of clients.

Methods and apparatus are also provided for facilitating a first conference on a network between a first client and at least one other client. A first request to join the first conference is transmitted to a dispatch server via the network. A dispatch command is received from the dispatch server. The dispatch command identifies a first one of a plurality of media servers. A second request to join the first conference is transmitted to the first media server in response to the dispatch command from the dispatch server. A connection is established with the first media server by which the first client may participate in the first conference.

According to another embodiment, methods and apparatus are provided for facilitating a first conference on a network between a first client and at least one other client. A graphical user interface is transmitted to the first client via the network. The graphical user interface includes an object corresponding to the first conference. First data are transmitted to the first client via the network. The first data identify a remote conferencing system. The remote conferencing system includes a plurality of media servers coupled to the network, and a dispatch server coupled to the network for statelessly dispatching the first client to the first conference on one of the media servers. The dispatch server is operable in response to a request from the first client to join the first conference to either determine which of the media servers is facilitating the first conference, or create the first conference on a first one of the media servers where the first conference is not currently being facilitated.

A further understanding of the nature and advantages of the present invention may be realized by reference to the remaining portions of the specification and the drawings.

### BRIEF DESCRIPTION OF THE DRAWINGS

FIG. 1 is a simplified block diagram of a network communication system designed according to a specific embodiment of the invention;

FIGS. 2a and 2b are flow diagrams illustrating the addition of a client to a conference according to a specific embodiment of the invention;

FIGS. 3-5 are a simplified block diagram of the configuration of an authentication server, a dispatch server, and a media server, respectively, according to various specific embodiments of the invention;

FIGS. 6a-6c illustrate the structure of the mesh service according to a specific embodiment of the invention;

FIG. 7 illustrates the configuration of a mesh service according to a specific conferencing embodiment;

FIG. 8 illustrates the configuration of a mesh service according to a specific point-to-point embodiment;

FIG. 9 illustrates the configuration of a mesh service according to a specific arena embodiment;

FIG. 10 illustrates the configuration of a mesh service according to a specific classroom embodiment;

FIG. 11 illustrates the configuration of a mesh service according to a specific panel discussion embodiment;

FIG. 12 illustrates the configuration of a mesh service according to another specific panel discussion embodiment;

FIG. 13 is a representation of a graphical user interface on a client machine according to a specific embodiment of the invention;

FIG. 14 is a simplified block diagram of a client plug-in designed according to a specific embodiment of the invention;

FIG. 15 is a simplified diagram of a network environment in which the present invention may be implemented; and

FIG. 16 is a block diagram of a computer architecture for use with various embodiments of the present invention.

### DETAILED DESCRIPTION OF SPECIFIC EMBODIMENTS

In describing the various embodiments of the present invention, reference is made to various hardware configurations, communication protocols, and software architectures. It will be understood, however, that the present invention is much more widely applicable than the specific embodiments described herein. That is, the architecture of the present invention is not protocol or media specific and may be adapted to any protocol or any kind of media. Moreover, even though a Java implementation is described, other software architectures may be employed to implement the present invention. Therefore, in determining the scope of the present invention, references should be made to the appended claims.

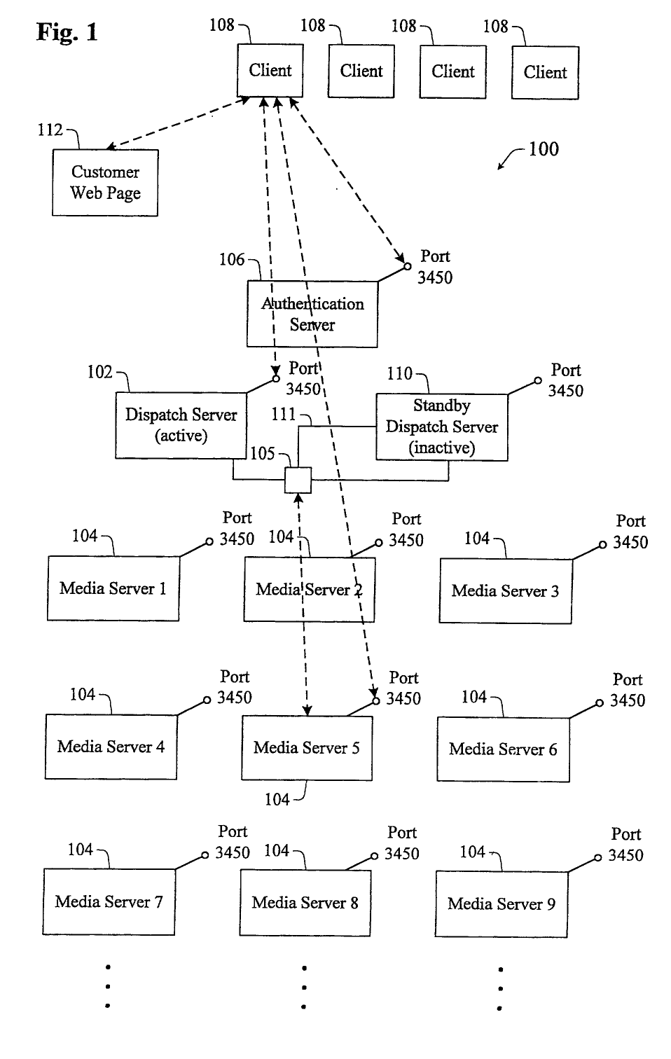

FIG. 1 is a simplified block illustrating a network operation center (NOC) 100 designed according to a specific embodiment of the invention. The various entities in FIG. 1 reside on and communicate via a network (not shown). The network may be a local area network (LAN), a wide area network (WAN), or, for example, the Internet. According to one Internet embodiment, NOC 100 resides directly on a high bandwidth backbone (not shown) such as the one provided by Qwest Communications, Inc. of Denver, Colo. A dispatch server 102 manages a plurality of media servers 104. The term media server is used herein to make it clear that the communications facilitated by media servers 104 can be by any of a variety of media including, for example, audio, video, text, etc. Each of media servers 104 registers with dispatch server 102 which “listens” on port 3450 for clients requesting access to the system. In fact, media servers 104 also listen for clients on port 3450. Dispatch server 102 maintains a “slave list” of all currently registered media servers 104. The slave list includes the IP addresses of the registered media servers and whether they are currently active. When a media server 104 goes down, it notifies dispatch server 102 which makes the appropriate change to its slave list. An authentication server 106 provides an additional level of security by requiring validation of all requests from incoming clients 108 to participate in conferences on NOC 100. According to one embodiment, dispatch server 102 communicates with media servers 104 and clients 108 via switch 105.

According to one embodiment, a further security layer is provided in the dispatch mechanism of the present invention. According to this embodiment, when one server (e.g., a dispatch server) dispatches a client to another (e.g., a media server), the first server then calls the second which places the client on a will call list. Any calls from entities not on the will call list of the second server are rejected.

According to a specific embodiment, a second standby dispatch server 110 is provided to replace dispatch server 102 in the event that dispatch server 102 goes down. The role of standby dispatch server 110 is to monitor the health of dispatch server 102 and detect failures on the application as well as the hardware level.

As will be discussed below, active dispatch server 102 runs the dispatch mechanism of the present invention. It also registers all active media servers 104, maintaining a slaves list thereof. The slaves list and the Master service (described below) are mirrored on standby dispatch server 110. According to one embodiment, a platform-independent Java application triggers updates on standby server 110 when either file is modified. File synchronization is achieved by standby dispatch server 110 (designed in Java).

Standby dispatch server 110 runs a standby service (not shown) which monitors the heartbeat of the dispatch application on server 102 using an ultra light RMI call to the Master service (described below) on dispatch server 102. Standby server 110 also monitors the heartbeat of any of a variety of machines on the network which validate the health of the main dispatch interface on active dispatch server 102. These machines may include, for example, the default gateway, any of the media servers, an administrative server (i.e., an auxiliary server for performing administrative functions), etc. Thus, a heartbeat failure corresponds either to a complete hardware failure of active server 102, failure of the Master service on active server 102 to respond, or a failure in pinging the default gateway. In the case of a ping failure at least one other entity is pinged to ensure that switch over occurs only when the main dispatch network interface for server 102 is unhealthy.

If any of the monitored heartbeats fail, standby server 110 triggers a switch over. According to a specific embodiment, the reason and time of the switch over are logged. Then Standby server 110 uses reflection through serial connection 111 to disable the port of switch 105 by which the main dispatch ports of both servers 102 and 110 are connected to the network, and takes over the IP address previously owned by dispatch server 102. Once this is done, standby dispatch server 110 stops executing the standby service and commences operation as the active dispatch server. At this point, a system administrator is informed of the failure and switch over using an alert-page or some other integrated solution. Because standby dispatch server 110 now has the same IP address as previously owned by active dispatch server 102, operation of the system continues as if there were no interruption.

According to various specific embodiments, authentication server 106 may be made redundant in a manner similar to that described above with reference to dispatch server 102. That is an inactive standby authentication server may be provided to take over the authentication function if authentication server 106 ever goes down.

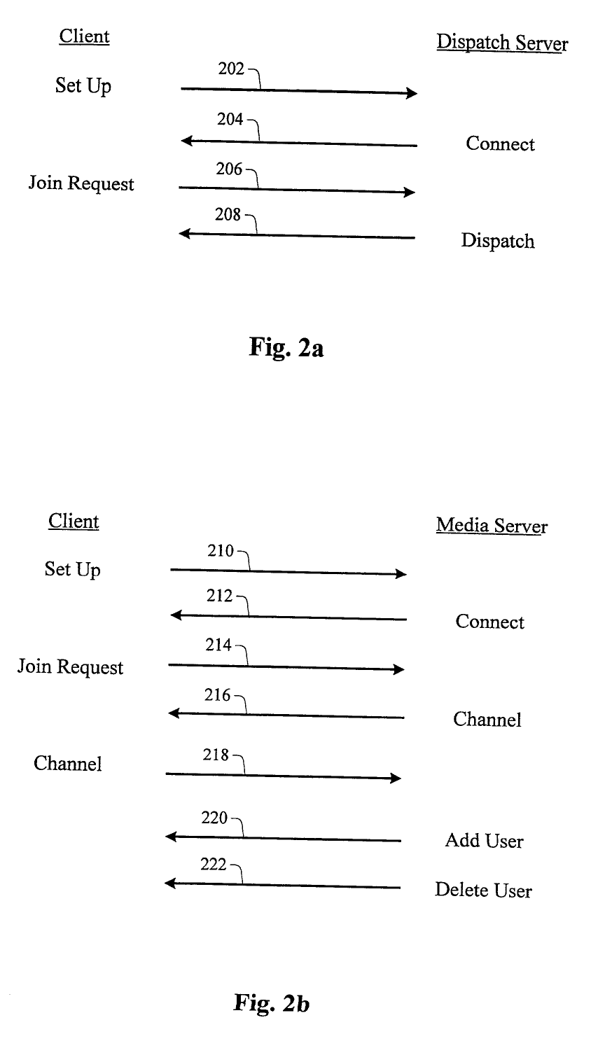

An example of the operation of NOC 100 will now be described with reference to FIGS. 1, 2a and 2b. The dashed arrows in FIG. 1 represent the lines of communication between the devices. A client 108 initially connects with a web page 112 which is maintained by a customer of NOC 100. By viewing web page 112 or clicking on a link in that page, client 108 indicates that its user wishes to participate in a conference which will be referred to in this example as conference XYZ. If client 108 does not have the client plug-in (described below) which allows it to communicate with NOC 100, the plug-in may be quickly downloaded and installed on client 108. Once client 108 has the client plug-in, customer web page 112 gives client 108 the IP address of authentication server 106 and an account number or authentication code which is used for authentication purposes.

Using the IP address obtained from the customer web site, client 108 contacts authentication server 106 requesting to join conference XYZ. Authentication server 106 receives the join request from client 108 via port 3450 and, upon validation of the request, dispatches client 108 to dispatch server 102 by providing its IP address to the client. Validation of the request may be accomplished by comparison of the account number or authentication code accompanying the request with a list of valid accounts accessible to authentication server 106. Alternatively, the request may be preceded by a communication from the customer web site alerting authentication server 106 of the impending request and providing authentication information.

Client 108 places a set up call (202) initiating the opening of a TCP socket to dispatch server 102 using the IP address obtained from authentication server 106 (syn, syn/ack, ack). In response to the set up call, dispatch server 102 transmits a connect command (204) to the client. Additional authentication or validation of the request may be performed by dispatch server 102. Alternatively, dispatch server 102 may be the first point of contact with the system and perform all authentication functions. That is, according to specific embodiments, an additional authentication server 106 is not used.

Once the TCP connection is established, client 108 sends a join request (206) to dispatch server 102 with a plurality of parameters. These parameters may include: the conference name, an account number, user name (if know else the user is prompted), web host IP (may be determined programmatically for validation of origin), operating system, browser, browser version, sound card, sound card driver, etc.

Upon receiving the join request from the client to join conference XYZ and validating the origin of the request, dispatch server 102 determines whether conference XYZ exists by polling all of media servers 104 on its slave list. If XYZ conference is running on a particular server 104 (e.g., Media Server 5), dispatch server 102 transmits a message to client 108 which includes the IP address of the relevant media server 104 (208). That is, dispatch server 102 dispatches client 108 to the IP address of the media server 104 on which conference XYZ is currently being facilitated. This causes client 108 to disconnect from dispatch server 102 by sending an ENDSESSION message and operating a four stage classical disconnect (fin, ack, fin, ack), and place a new stateless set up call (210) to Media Server 5, i.e., the same call with which the client originally made contact with authentication server 106 and dispatch server 102. In response to the set up call, Media Server 5 transmits a connect command (212) to client 108 in response to which the client transmits a join request (214). This time, however, because conference XYZ is running on Media Server 5, Media Server 5 establishes a channel (216) to let the client know on which channel it will be listening. The client transmits a channel command (218) to let the server know to which channel to transmit. The client is thus connected to the desired conference and may begin transmitting and receiving audio and/or video data.

Information regarding the other participants in the conference are transmitted from Media Server 5 to client 108 via an add user command (220). This information includes at least the users' names and may also include other information such as, for example, the other users' IP addresses. The names of the conference participants may then be displayed on each client's user interface. Each time a new client joins the conference, all of the other clients receive an add user command from the media server. Similarly, each time a client exits the conference, each remaining client receives a delete user command (222) which results in the removal of the deleted user's name from the user interface. Conference XYZ exists until empty, i.e., until the last client exits, at which point it vanishes as if it never existed.

If after receiving join request 206 dispatch server determines that conference XYZ does not currently exist, dispatch server 102 polls all of the active media servers 104 to determine which has the most free capacity. If Media Server 5 replies that it has the most free capacity, dispatch server 102 sends a message to Media Server 5 triggering creation of conference XYZ on Media Server 5. Then dispatch server 102 dispatches the client to conference XYZ on Media Server 5 in the manner described above.

As described above, the media server in which a particular conference is created is determined by which media server reports the most available capacity to the dispatch server. The available capacity of a media server may be estimated in a variety of ways according to various embodiments of the invention. According to one embodiment, if a channel is opened to a media server, the media server's capacity is determined to be diminished by the bandwidth allocated to the particular type of channel, e.g., video or audio. By contrast, for a system in which there is only one type of channel, e.g., audio, the media server need only keep track of the number of current users. Capacity may also be measured in terms of CPU units or bandwidth units. Because the dispatch server doesn't care how the media servers estimate their capacity, the estimation can be modified or made more sophisticated over time without having to make major architectural changes. According to one embodiment, capacity is measured by the number of conferences multiplied by some predetermined number of users. This mechanism may be used to effectively reserve conference capacity according to a customer's wishes. That is, a customer ISP may enter into a contractual arrangement with the NOC according to which any conference associated with that ISP is allocated the bandwidth resources to support the predetermined number of clients. Thus, even where fewer than the predetermined number of clients are participating in a given conference on a media server, the media server will report its available capacity to the dispatch server as if the predetermined number of clients are participating in the conference. This mechanism serves as a guarantee to the customer ISP that at least that number of clients will be able to participate in the conference.

The dispatch mechanism described above is essentially the scaling mechanism of the present invention. In other systems, scalability is typically obtained by maintaining and tracking state information. By contrast, the system of the present invention remains completely stateless. One of the benefits of being stateless is that the system can be dynamically reconfigured without the requirement that current state information be communicated.

Moreover, the dispatch mechanism may be used for a variety of functions. It can be used as described herein to dynamically recreate conferences in the event that a server goes down. That is, in such a situation, the users in a particular conference on that server may be dispatched to another server for recreation of the conference. The dispatch mechanism may also be used to implement features useful to the ISP customer. For example, if a user is talking to a sales representative at an e-commerce web site and wants to talk to the manager, the dispatch mechanism may be employed to effect dispatch of the user to the manager. As will understood, there are a wide variety of functions that may be derived from this powerful mechanism which are contained within the scope of the present invention.

One way to think of the system is that it creates numerous small conferences, i.e., each beginning with one client. Each of the conferences is facilitated on one of the media servers 104. As clients are added to a particular conference, that conference bottom fills like a glass being filled with water. Because of this, there is a risk that the conferences on any single media server could accumulate so many users that the server's capacity is exceeded and data begins to get dropped. To address this possibility, a specific embodiment of the invention enables the media server to notify the dispatch server when it needs to “punt” one or more of its conferences due to a variety of conditions such as, for example, the server going off line, or current traffic exceeding the server's capacity. Then, using the dispatch mechanism of the present invention, the punted conference or conferences may be reconstructed on one of the other media servers with little or no noticeable latency. That is, the punting media server dispatches the clients of the punted conference either back to the dispatch server or another media server on which the conference will be reconstructed. In other words the usual mechanism for conference creation via the dispatch server can be used, or the dispatch server can determine where the conference should be reconstructed and communicate the IP address of the new media server to the current media server so that the participant clients may be dispatched to the new server directly. Any time the clients are given such a dispatch, they hang up and call whatever server they are instructed to call at which point the conference may be reconstructed. Thus, the client is relatively stateless as well, i.e., a client could be in one server for half and hour, get dispatched and end up in another for the remainder of the conference, all of this being transparent to the end user.

When a media server goes down, the dispatch server is typically the first to know because it is constantly querying the media servers regarding the location of specific conferences and available capacity. As described above and according to a specific embodiment, the dispatch server does nothing out of the ordinary when it determines that a media server is going off line except make the appropriate alteration to its slave list. That is, the dispatch server allows the conferences on the downed server either to be dispatched by that server as its going down, or to be reestablished according to the original procedure, i.e., the clients reestablish contact with the system and recreate the conference. However, according to alternative embodiments, system management tools are provided which more proactively handle such server crashes. For example, out-of-band signaling between machines can alert system management of problems. According to other embodiments, quality-of-service tools continuously collect latency data for all of the media servers in the NOC. If the latency data indicate at run time that a particular server requires more or less CPU than originally anticipated, adjustments to that server's capacity may be made.

The open architecture of the present invention avoids having to dedicate the bandwidth of specific servers to specific customer web pages or requiring the customer or the client to call up in advance to arrange a particular conference. According to the invention, conferences are created spontaneously and bandwidth is allocated dynamically. Thus, the customer web site can create whatever conferences they want and arrange users in whatever groupings they want, being limited only by the amount of utilization capacity for which they have contracted with the NOC. According to a specific embodiment, utilization capacity is based on user capacity, i.e., a maximum number of simultaneous users, rather than dedicated resources. It will be understood that, as with electric power generation, the total capacity of the system can be overbooked in accordance with usage statistics. For example, advantage can be taken of the fact that usage peaks in Japan are complementary with those in the United States.

In this area, there are several specific problems which are currently confounding ISPs. For example, when clients connect in current systems, they must stay connected to the same server to communicate. This is obviously undesirable in situations in which the server's capacity is exceeded or in which the server goes off line. In addition, there is the logistical problem presented by the thousands and thousands of clients all over the Internet that must somehow find each other. This brings up the related problem of how to get participants in the same conference to connect to the same server at the same time.

A single server architecture can operate in the face of these problems provided the number of clients and conferences serviced by the server is limited to a relatively small number. Unfortunately, from the point of view of most ISPs, this is not an acceptable solution. A multiple server architecture can address the issues regarding the overall number of clients to be serviced, but with more than one server, the problem becomes how to determine when and where to create a particular conference, and how clients will know with which of the multiple servers to connect (i.e., the different servers have different IP addresses).

A real-time communication system designed according to the present invention solves all of these problems. The dispatch server of the present invention provides a single point of contact which communicates the location of conferences to clients. And, because of the stateless nature of the architecture, this is done without a complex communication protocol between the dispatch and media servers. That is, the typical model for scaleable architectures involves a tremendous amount of communication between machines as to who's got what (i.e., state data). The simple and stateless architecture of the present invention avoids this necessity.

Another scalability mechanism is also provided according to various embodiments of the invention. This scalability mechanism employs a middle layer of dispatch servers between the NOC's primary dispatch server and the farm of media servers. That is, the dispatch servers in the middle layer each have their own dedicated bank of media servers in which they create conferences, monitor media server capacity, and dispatch clients in the manner described above. The primary dispatch server remains the initial point of contact with the NOC except that, in this embodiment, the primary dispatch server is responsible only for communicating with and dispatching clients to the dispatch servers in the middle layer. Thus, if a client contacts the primary dispatch server requesting to join a particular conference, the primary dispatch server contacts the middle layer of servers to determine where the conference is located. Each of the middle layer of dispatch servers then determines if one of its media servers is facilitating the conference, and if so, reports this to the primary dispatch server which dispatches the client either to the reporting dispatch server or directly to the relevant media server if the IP address of the media server is reported to the primary dispatch server.

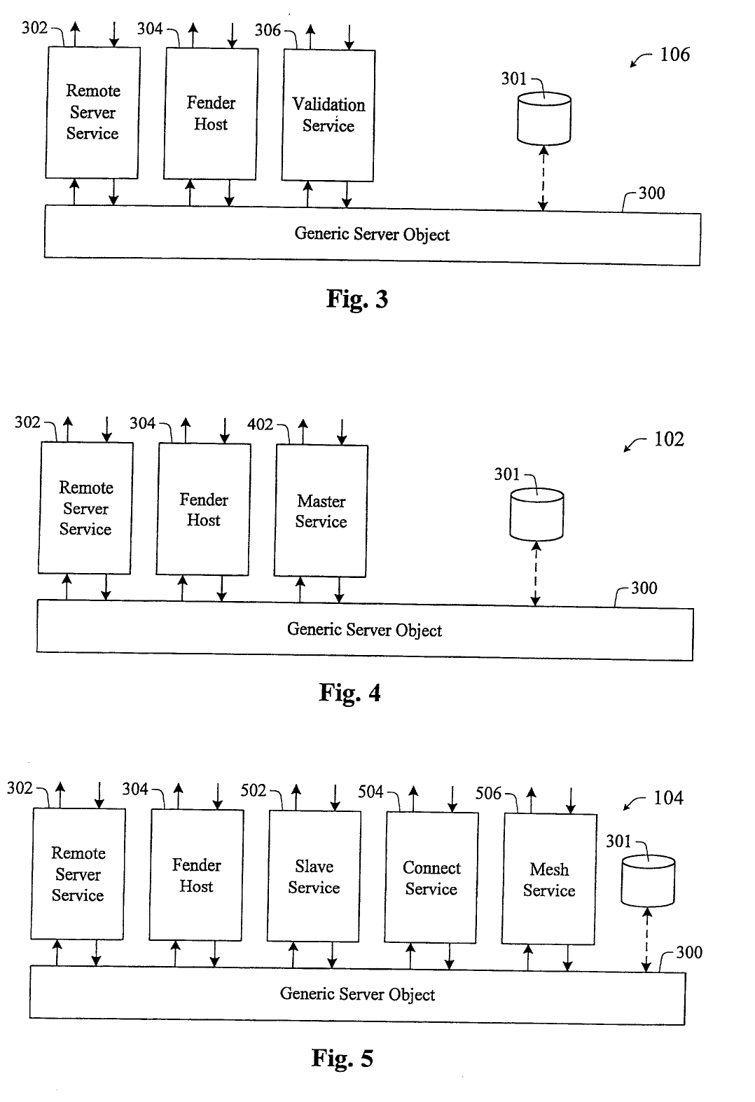

FIGS. 3-5 are simplified block diagrams of the configurations of an authentication server 106, a dispatch server 102, and a media server 104, respectively, designed according to various embodiments of the invention. Authentication server 106, dispatch server 102, and media server 104 are all modeled after the same architecture. The main differences between the servers are in the service classes installed on each. That is, server object 300 is the basis for dispatch server 102, media server 104, and authentication server 106. According to a specific embodiment, server object 300 is a Java based server running on an NT operating system. Server object 300 employs the NT server model in that services are installed on top of server object 300 which have start, stop, pause, and resume interfaces with server object 300. Server object 300 on each of the different types of servers has access to a system memory 301 which stores a list of the services employed by that server (described below).

Server 300 provides basic application services such as configuration, logging, tracing, startup, orderly shutdown, and remote access. Server 300 runs services which perform the actual application functionality. Many services are used in multiple different applications, as they too are built to be general purpose and re-usable. Re-using the same code in multiple applications makes the software more robust and maintainable.

Server 300 utilizes an object-oriented event model based on the model used in the Java user-interface system. Objects in the system have incoming methods and fire outgoing events. The events are multicast so that multiple objects can subscribe to another object's events. Every object that fires events offers add listener and remove listener methods for that event. A “Remote Event” nests other events. This allows other processes or machines on the network to listen for events remotely.

Server 300 loads and manages a configuration file on startup that can be accessed by any service run by the server. From this file, it loads the class names of the services it is to run. This determines what server application will be run by the machine. It provides methods to set and get configuration properties, and creates and starts the services it found in the configuration file. Server 300 fires events when a configuration variable is changed, and when a new service is created. This has the advantage that the configuration of the system may be changed dynamically without the necessity for rebooting.

The services running on server 300 are all based upon a single service class. The generic service class provides remote access, convenient access to the base server object, and full support for tracing and event logging. The basic service fires trace events and log events. Each service has a published interface accessible remotely via Java's Remote Method Invocation (RMI) mechanism. The interface includes an incoming interface for receiving methods and an outgoing interface for firing events. The RMI mechanism provides system flexibility in that it allows any of the services to exist across machines.

Remote server service 302 facilitates remote access to the server via the RMI mechanism. It allows remote programs to restart, stop, query, and configure server 300. Remote server service 302 provides the remote interfaces to server object 300 by which remote configuration is achieved. Remote server service 302 also provides version information to remote applications.

A logger service (not shown) in server 300 provides a simple mechanism to log text information. The logger can be configured to log to a file, to the console, both, or neither. It runs a separate output thread to buffer file output for increased performance under high-stress conditions. A trace logger service (not shown) in server 300 inherits the logger service. When the trace logger service is started, it listens for “service added” events from server object 300. For every event, it listens for the new service's trace events. In effect, it listens for all trace events that happen in the system, and logs them to a file or the console, as configured.

An event logger service (not shown) in server 300 behaves like the trace logger service, subscribing for all log events in the system. These can be reported to a file or to the console, as configured.

A client host service 304 is a call control service which facilitates the connection to clients. This service isolates the protocol between the client and the server, providing methods and events that correspond with connection and other protocol-related tasks. Client host service 304 creates remote user objects that represent currently connected clients. It fires connection, disconnection, text message, ignore, and other events. Each remote user object provides remotely-accessible methods to send text messages, disconnect, add and remove users from the roster, and place requests for channels to be opened up with a given media type.

Authentication server 106 includes a validation service 306 which performs the function of authenticating or validating an incoming request, triggering dispatch of the join request if valid, or rejection of the request if invalid. According to various embodiment, validation may be determined with respect to account numbers or codes identifying traffic from customer web pages which may be stored in the system memory, or received from the customer immediately in advance of incoming request.

Master service 402 performs the primary functions of dispatch server 102. It maintains a list of slave machines, i.e., media servers, and communicates with the slave service 502 on those machines. Master service 402 handles calls from the call control service. As discussed above, if a conference requested by a client does not exist on any of the connected slave media servers, it is created on the slave with the most available capacity. The slave may be a media server or another dispatch server. The call is then dispatched to the server on which the conference was created.

Slave service 502 is the counterpart to the master service 402 and resides on media servers 104. It listens for commands from master service 502 and passes them on to the main local service; either another master service in the case of a dispatch server, or a groups service (describe below) in the case of a media server. If the server is shut down or experiences a fatal exception, slave service 502 notifies master service 402 that it is shutting down. According to a specific embodiment, in the event of a shut down of a media server, the corresponding slave service 502 dispatches all connected clients to master service 402 for recreation of their respective conferences on another server.

Master service 402 and slave service 502 are complementary services which cooperate across machine boundaries and effect the dispatch mechanism of the present invention. As mentioned above, master service 402 typically runs on a dispatch server, while slave service 502 typically runs on a media server. It should be noted, however, that a dispatch server may run slave service 502 as well. Master service 402 dispatches clients to the media servers and triggers conference creation on the media servers. Slave service 502 creates conferences in response to a command from the master, and adds or deletes users from the conferences. The slave service also triggers creation of mesh components (described below) corresponding to new conferences and new users through the groups service as will be described. According to a specific embodiment, slave service 502 also determines its media server's current available capacity.

In addition, in response to a configuration change, e.g., a new dispatch server coming on line, slave service 502 gets a parameter from the config called “dispatch master” which is set to an IP address identifying the master service on the new dispatch server. Slave service 502 then calls a register method on the master. The contact information of slave service 502, i.e., the Java Inet which includes the host name and IP address, is then added to the slave list of slaves maintained by the master. When a media server shuts down, its slave service calls an escape method on the master. On start-up or when given a dispatch master (i.e., a config change event turns out to be a dispatch master), slave service 502 registers immediately with the appropriate master. This is part of the dynamic configuration capabilities of the system.

According to various embodiments, slave service 502 also stores a time stamp for each client corresponding to the time when the client joined a conference. When the client leaves the conference this is fired out as an event which is stored in a log file. This information may be used, for example, to generate usage reports or billing information for customers.

A specific embodiment of the dispatch mechanism of the present invention will now be described in greater detail with reference to FIGS. 3-5. Each of servers 102, 104, and 106 has a client host service 304 which listens on port 3450 and which facilitates communication with clients. That is, client host 304 on each server is a generic object which facilitates the connection between a client and the server. Client host 304 manages the client from the server's point of view, i.e., it abstracts the client connection protocol from the server. The client speaks a simple TCP text protocol, i.e., tabs delineating parameters with the end of the line delineating commands.

Despite the fact that specific embodiment of the invention are described with reference to port 3450, it will be understood that different ports may be used to facilitate communication with clients. Specifically, a port which is open in most firewalls by default would be an excellent candidate.

Operation of client host service 304 proceeds as follows. When the client is given an IP address to call, e.g., by the customer web page (the IP address could be an authentication server, dispatch server, or a media server), the client places a call to port 3450 of the IP address transmitting the “set up” command as discussed above with reference to FIG. 2. Client host 304 then transmits a “connect” command which confirms to the client that it has found the correct server. The client sends a “join” request with a bunch of associated parameters including the conference name and the referring web server IP address. This information may be determined programmatically from an account number corresponding to the customer and reported by the client's browser. This would be difficult to spoof thus providing one layer of security. Additional security is also likely be provided at the customer site, e.g., restricting access to the web page. Other parameters sent with the join request include information regarding the client's sound card, operating system, browser, application, client version, driver version on sound card, etc.

If the server is the dispatch server 102, the master service 402 would then determine to which media server the client should be directed, client host 304 then issuing a dispatch command instructing the client to connect with a particular media server. At this point the client starts the process over with the media server, i.e., set up, connect, join.

If the server is a media server 104, client host 304 sends a channel request to the client and the client sends a channel request to the media server. With these two commands, the client and the media server are essentially negotiating the ability to send a particular kind of data, e.g., audio, on a given channel. The channel command from the client host lets the client know that it has found a location for its conference and that it can open a channel for a specific type of media on a given port. Other processes in client host 304 include add user, delete user, and keeping an up-to-date list of users in a given conference.

The client host service is a generic object which does not effect the actual connection, conference creation, etc., it only fires events and issues five commands, i.e., connect, dispatch, channel, add user, delete user, in response to the various inputs. For example, in response to receiving the set up command from the client, the client host service fires off the event “New User” with all of the appropriate client information supplied by the client. In response to a join request from the client, client host fires of the event “Join Request” with its associated elements. In response to the events fired by client host, and depending upon which type of server is receiving the call, either the master or the slave calls the appropriate methods, e.g., accept join, reject join, dispatch.

As mentioned above, the client host service is generic. In fact, the server architecture of the present invention is an extremely flexible plug-and-play architecture in that a subset of the available service classes may be used to create a new kind of server. For example, a text chat server could be configured using the remote server service, the client host service, the groups service, and a mesh service which pipes text rather than audio data.

In addition to slave service 502 and client host service 304, a media server 104 includes a connect service 504 and a mesh service 506. The connect and mesh services are media server specific entities which work very closely together. Mesh service 506 pipes various media data (e.g., audio and video), and connect service 504 configures the mesh according to the specific connectivity scheme. In one group conference embodiment, connect service 504 comprises a groups service which organizes clients into groups and configures the mesh to facilitate conferences among the members of each group.

Groups service 504 registers with the corresponding client host service 304 on the same media server requesting all of its events. Groups service 504 calls accept or reject when a join event is fired, dispatch when, for example, the server is shutting down, or creates a conference. When groups service 504 gets calls regarding a new channel, it calls mesh service 506 to set the channel up. Groups service 504 may be thought of as a special case of a more generic “connect” service. That is, mesh service 506 may be configured in a wide variety of ways, e.g., group conferences, arenas, etc. The groups service may thus be replaced by some other connect service to configure the mesh appropriately for the corresponding application. The manner in which the groups service configures the mesh service will be described in greater detail in the discussion of the mesh service.

Each of the services are essentially “agnostic” in that they look “down” but not “up”. That is, they know about the services below them from which they receive events and to which they issue method calls, but they don't know about the services above them to which they fire events and from which they receive method calls. For example, the groups service knows about the mesh service, but the mesh service doesn't know (or need to know) about the groups service. Thus, if it becomes desirable to organize clients into an “arena” with rows, a podium, etc., the groups service could be replaced by an arena service which would have a similar relationship with the mesh and client host services as does the groups service. And, because neither the mesh service nor the client host service know anything about the groups service, this can be done without modification to the other services.

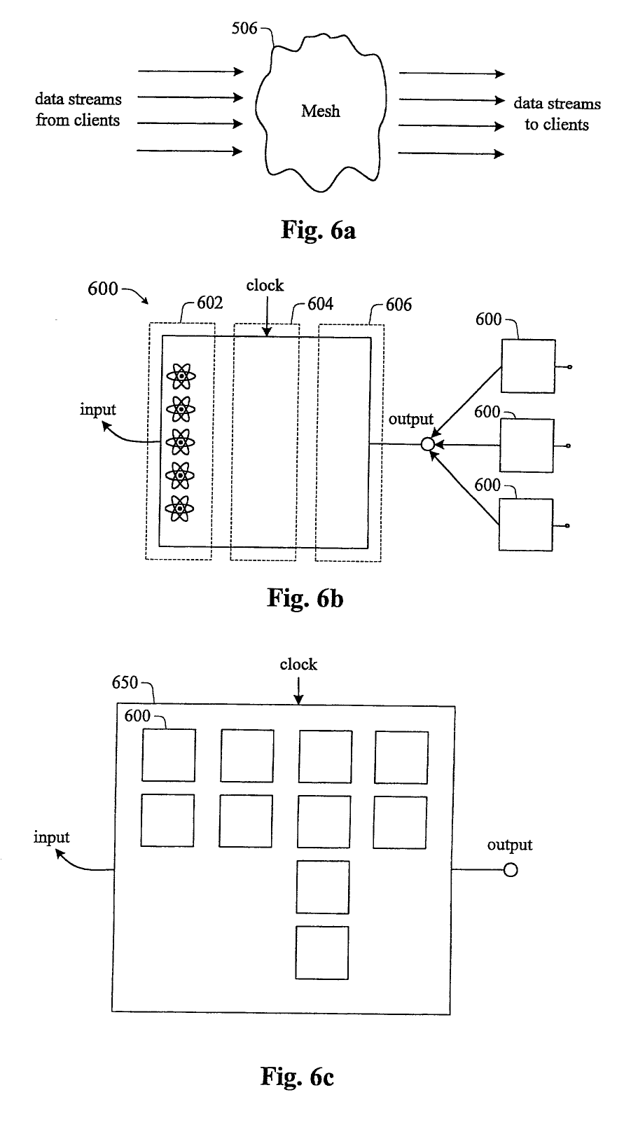

Mesh service 506 provides media routing components that can be connected to create various applications. It does no connections itself, it merely runs the connections set up by other services. Mesh service 506 takes incoming data streams from clients and transmits outgoing data streams to clients (see FIG. 6a). Mesh service 506 may be configured or “wired” in a wide variety of ways to implement specific types of communication. That is, mesh service 506 is generic to the various different embodiments of the invention (group conferencing, arenas etc.). In each such embodiment, mesh service 506 is configured by another controlling service. For example, groups service 504 configures mesh service 506 for audio or video conferencing. By contrast, an arena service (described below) may replace the groups service and configure the mesh for an arena embodiment. Alternatively, a point-to-point service may be used in place of either the groups or arena services to effect point-to-point communication. It will be understood that there are a wide variety of ways in which the mesh service of the present invention may be configured to provide a desired connectivity and a corresponding connect service for each, and that each such connect service and mesh configuration is within the scope of the present invention.

Mesh service 506 may be thought of as a generic traffic routing system which allows clients in a group to hear more than one member of the group at a time and to hear other group members even while they are speaking. It is flexible enough to also allow for selection of individual streams for dominance or for silencing.

The basic building block of mesh service 506 is an object shown in FIG. 6b and referred to herein as a “chip.” Chip 600 is a software construct which behaves in a manner somewhat analogous to hardware. The fundamental unit of data which flows through the mesh (and the chips of the mesh) is referred to herein as an “atom”. Any text message, audio stream, or video stream in the system is organized into atoms 602 for transmission through the mesh service. The make up of an atom may vary according to various embodiments of the invention. That is, an atom may represent one packet of data in some standard protocol format. Alternatively, an atom may represent multiple packets, or even a portion of a single packet. In any case, each atom represents and points to some block of media data. Each atom is also characterized by a priority and identifies the client of origin.

As shown in FIG. 6b, each chip 600 allows other chips to connect to their output stages. The direction of the arrows in the diagram are opposite the direction for hardware diagram to reflect the fact that the chips on the right are subscribing to the output of the chip on the left. A chip receives atoms from other chips in an input queue 602. Mesh service 506 calls a clock method 604 on chip 600 that causes the derived class to do whatever task it is assigned. Specific instantiations of the chip class with differing functionalities will be discussed below. Any atoms output by chip 600 during its clock method are received in the input queue of chips connected to the chip's output 606.

A special kind of chip is shown in FIG. 6c and is referred to herein as a “board.” Board 650 inherits from chip 600, adding an “add chip” method. The “add chip” method adds chips to the board and defines the stage of the board to which the chip is added. Board 650 is an example of a board having four stages, i.e., chips 600 have been added to stages 1, 2, 3 and 4. In the example shown, “add chip” is called 10 times with 2 chips 600 being added to stage 1, 2 chips 600 to stage 2, 4 chips 600 to stage 3, and 2 chips 600 to stage 4. The inputs of the chips of a particular stage are “wired” to the outputs of the chips of the previous stage to implement the desired connectivity and functionality. The chips in stage 1 are “wired” to the input of board 650 and the chips on stage 4 are “wired” to the output of board 650. When the board is clocked (by its clock method), all of the chips on the board are clocked one stage at a time, moving the atoms from left to right with each clock. In addition, board structures may be nested with boards being added to the stages of other boards such that extremely complex functions can be implemented.

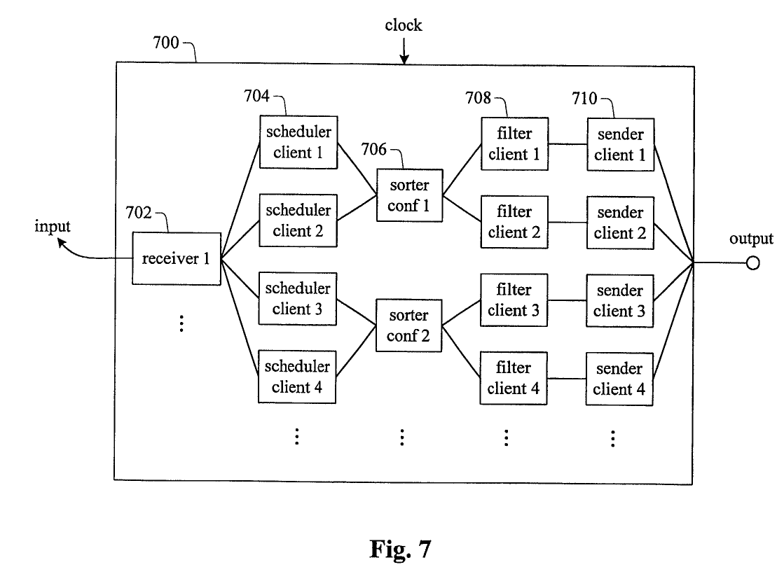

A groups conference embodiment of the invention in which a groups service controls and configures the mesh service will now be described with reference to FIG. 7. In this embodiment, each media server has a mesh service which is configured as a large multistage board 700. The first stage of board 700 includes one receiver chip 702 for each type of media, e.g., audio, video, etc., handled by that board. Therefore, each media server which handles audio has one receiver chip 702 which listens for audio data on a specific port, e.g., UDP 3450 or UDP 7000, and transforms RTP (real time protocol) packets to atoms, i.e., the fundamental unit of data in the mesh. An RTP packet is composed of a header and data. The header includes a time stamp (which indicates the time packet was transmitted), a source ID (used to identify client), and a sequence number (for identification of missing packets).

This embodiment of the present invention uses RTP to transmit audio data packets because RTP typically runs on top of UDP/IP rather than TCP/IP. UDP differs from TCP in that packets are not guaranteed to be delivered. Since a voice packet is only useful if it arrives in time to be played, this is preferable to TCP, which keeps re-transmitting packets until they are delivered. In addition, UDP is a socketless connection, so a single port on the server handles all clients. This vastly simplifies firewall issues. Of course, it will be understood that a wide variety of communication protocols are adaptable to the principles of the present invention.

RTP packets contain information on sequence and playtime, allowing an endpoint to know what may have been missed and to know when a packet arrives too late to be played. If packets start arriving late, both the client and the media server will increase the depth of their buffers, adaptively trading latency to insure minimal packet loss. If conditions improve, the buffers are dynamically reduced to decrease latency.

It takes time for packets to leave a client and travel across the Internet to their destination. In a voice application, this translates into a delay between the time the voice is spoken and the time it is heard on the other end. This delay is called latency. Studies have shown that in two-way conversation, if latency exceeds 500 ms, participants start having difficulty maintaining the conversation, and resort to signaling each other when they are finished speaking.

There is latency induced in both the client and server software processing. This is necessary, but can be tuned to minimize the delay and still get good server performance. The biggest variable in latency is the Internet itself. Clients communicate only with the media server, so the latency between the client and the media server is the essential factor.

Eliminating latency for Internet voice communications involves bending the Internet itself to your will. One way to make this possible is to use centralized servers, so at least one endpoint is fixed. This endpoint needs to be extremely well connected to all ends of the Internet, and needs to be on a network that has minimal end-to-end latency. The idea is for the latency to be deterministic (that is, stay on a homogenous network) for as much of the trip as possible. As latency problems are identified, they can be addressed by instituting peering relationships between the network hosting the server and the network experiencing problems.

As discussed above, an atom is a reference to the data packet from which it was derived. According to one embodiment, the atom refers to a portion of a packet by referring to the packet and an offset value in that packet. According to a more specific embodiment, the atom size is the frame size of the particular codec (e.g., Pure Voice from Qualcomm of San Diego, Calif.). Being able to break up packets into smaller portions reduces the average latency per unit of data for high speed clients because of the ability to buffer smaller chunks of data.

Referring back to FIG. 7, the second stage of board 700 includes a plurality of schedulers chips 704, one for each client currently participating in a conference on the media server. Each scheduler chip 704 subscribes to the output of receiver chip 702. Scheduler chips 704 take the incoming atoms, select only those coming from the associated client, schedule when those atoms should be played, and place them in a queue. The selection of atoms from among all incoming atoms in the mesh is not as inefficient as it might first appear because of the fact that listeners typically outnumber talkers by a wide margin. The scheduling is done with respect to the RTP header info pointed to by the atom. That is, for example, if it is noted that packets are being dropped or are late from a particular client, the size of the buffer for that client can be increased which, while increasing latency for that client, improves sound quality. The idea is to minimize latency while maximizing voice quality.

According to a specific embodiment, the scheduler keeps track of and maintains the priority of each participant in each conference. That is, the scheduler maintains the priority field in each atom for each participant. According to one embodiment, the priority field of a participant's atoms changes dynamically according to a fairness algorithm which monitors the amount of talking by a particular client. That is, the longer a client talks the lower its priority decays, while the less a client talks, the higher its priority remains. This gives high priority, for example to a client which interrupts another that has been talking for awhile. According to a more specific embodiment, hysteresis is also built into the system to allow a client to build its priority back.

As will be understood, the priority field may be used in a variety of ways. For example, the highest priority could be assigned to an instructor in a classroom conference. That is, different classes or ranges of priority could be defined in which the fairness and hysteresis algorithms are independently implemented. In the case of the classroom conference, the teacher's priority would always be above those of the students.

Priority fields may also be used to insert high priority traffic into a conference such as, for example, an emergency broadcast. Other high priority traffic could include, for example, an audio advertisement directing the members of the conference to execute some action, e.g., key the microphone twice, if they wish to go to some remote site. The dispatch mechanism of the present invention could then be used to effect the transfer.

Fairness and hysteresis could be further combined with multiple priority ranges to implement, for example, a panel discussion (first priority range) with a moderator (highest priority range) and an audience (lowest priority range), with a microphone for audience members to participate (yet another range).

The third stage of board 700 includes a plurality of sorter chips 706, one for each conference on the media server. Each sorter chip 706 subscribes to the output of each of scheduler chips 704 associated with the conference to which the sorter chip corresponds. That is, each sorter chip 706 receives input from all of the clients currently participating in its conference and organizes them according to priorities (as determined from the atom's priority field).

Referring once again to FIG. 7, the fourth stage of board 700 includes a plurality of filter chips 708, one for each client currently participating in a conference on the media server. Each sorter chip 706 from the previous stage sends its output to each filter chip 708 associated with the conference to which the sorter chip corresponds. The purpose of filter chip 708 is to exclude the voice of the associated client so that the user does not hear her own voice. This is done by dropping all atoms identifying the corresponding client. According to a specific embodiment, filter chip 708 is also be used to exclude the voice of others in response to an ignore request(s) from the associated client. That is, a particular client may right-click on the name of a particular member of the conference in their user interface and select the ignore option. The selection of the ignore option is transmitted through the client host to the groups service on the media server which reconfigures the mesh service (specifically the client's filter chip 708) to exclude both the original client's voice and the voice of the party selected by that client.

The fifth and final stage of board 700 is a plurality of sender chips 710, one for each client. Each sender chip 710 is connected to a single corresponding filter chip 708 and is used to convert the received atoms back into RTP packets and send the packets out to the associated client. In the embodiments in which only n voices are supported at a time, the sender chip picks the atoms corresponding to the first n users in the list, converts them to RTP packets, and sends them to the client.

Each of the chips in the board 700 is extremely simple and has a simple job to perform. However, depending upon how they are configured on the board, complex and sophisticated functionalities may be realized. For example and as discussed above, the flexibility of this approach allows the board to be configured to implement arenas, class room conferences, panel discussions, point-to-point communication, etc. Moreover, chips may be added without affecting the manner in which the other chips on the board operate. For example, one such chip could communicate with a DSP card which could mix any number of voices.

As mentioned above with reference to FIG. 5, the groups service on the media server defines how the mesh service is configured for the audio conference embodiment. That is, the groups service calls the mesh methods which create, configure and connect the chips in the audio conference mesh service. The groups service essentially keeps track of all the clients in each group, i.e., conference.

When notified by the slave service that a new conference is being created, the groups service triggers creation by the mesh service of a corresponding sorter object and the appropriate interconnections. For each new client added to a conference, the groups service triggers creation by the mesh service of all of the corresponding mesh objects (i.e., the scheduler, filter, and sender objects) and their interconnections. The calls for creation and release of the objects and connections in the mesh are queued in the groups service and sent to the mesh service between clock transitions.

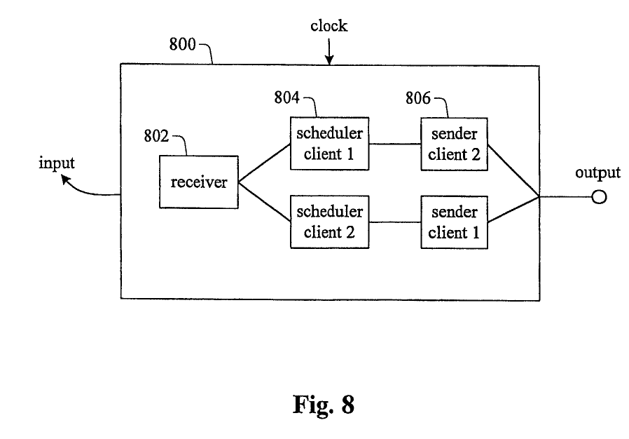

A specific point-to-point embodiment of the invention will now be described with reference to FIG. 8. As mentioned above, a point-to-point service is interchangeable with the groups service and defines how the mesh service is configured for the point-to-point embodiment. As the name implies, the point-to-point embodiment uses the system of the present invention to enable point-to-point communication between two clients. As will be understood, point-to-point communication via the present invention has many useful applications such as, for example, a viable alternative to computer telephony. Other applications include, for example, customer support functions in which a client can directly communicate with a customer representative by selecting an object at a company web site.

The point-to-point board 800 is a three stage board having a receiver chip 802 for each type of media supported by the server. The operation of receiver chip 802 is substantially the same as that of receiver chip 702 described above. That is, receiver chip 802 listens for media data on a specific port, e.g., UDP 3450 or UDP 7000, and transforms the received data to atoms, i.e., the fundamental unit of data in the mesh. The second stage of point-to-point board 800 includes a scheduler chip 804 for each client currently engaging in a point-to-point communication. As with scheduler chip 704 described above, each scheduler chip 804 takes the incoming atoms, selects only those coming from the associated client, schedules when those atoms should be played, and places them in a queue.

The third and final stage of board 800 includes a sender chip 806 for each client on the media server. Each sender chip 806 is connected to a single scheduler chip 804 and is used to convert the received atoms back into the appropriate form for transmission to the associated client. However, unlike the group conference embodiment discussed above, the scheduler chip 804 which queues the atoms from client 1 is connected to the sender chip 806 for client 2, and vice versa. That is, the data stream from client 1 is transmitted to client 2, while the data stream from client 2 is transmitted to client 1. This implementation avoids the need for the sorter and filter stages of FIG. 7. Of course, it will be understood that the group conference embodiment discussed above with reference to FIG. 7 may be employed to implement a point-to-point communication. That is, the number of participants in each point-to-point conference would be two. The point-to-point embodiment of FIG. 8 merely represents a less complex, alternative embodiment.

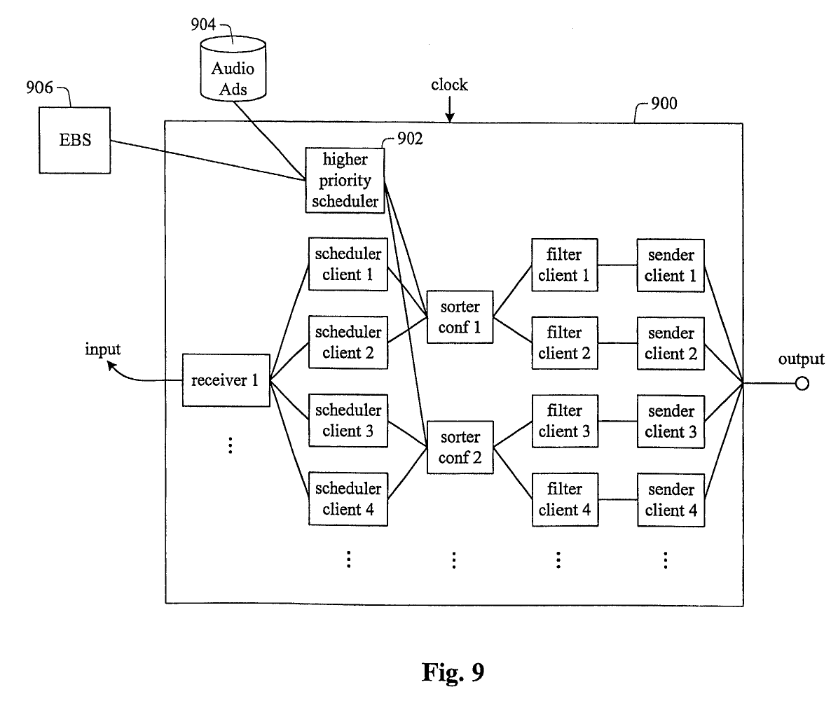

A mesh configuration for a conference embodiment with a high priority feed is shown in FIG. 9. As discussed above, certain data streams from specific clients or sources may be given a higher priority than other data streams for the purpose of playing those streams to all or some subset of clients at any given time. Conference board 900 is constructed and operates similarly to conference board 700 with the addition of a high priority scheduler 902 by which high priority data streams from, for example, an audio advertisement repository 904 or the Emergency Broadcast System 906 may be inserted.

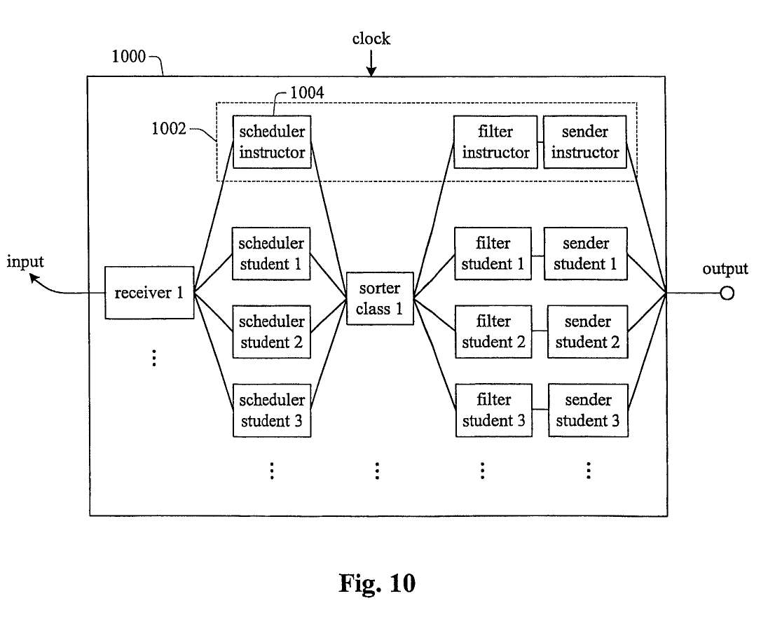

A mesh configuration for a classroom embodiment of the invention is shown in FIG. 10. In this embodiment, classroom board 1000 is configured and operates much like conference board 700 of FIG. 7 with each sorter corresponding to a particular class. In this case, however, the data stream from the instructor is given a higher priority than each of the students. As represented by the dashed line 1002 which includes the instructor's scheduler 1004, the instructor's priority remains above that of any student regardless of whether or not fairness and hysteresis algorithms are implemented. That is, no matter how high a student's priority gets (e.g., from remaining silent), or how low the instructor's priority decays (e.g., from talking), the instructor's priority will always exceed that of the student's. A single media server can handle one or multiple such classrooms.

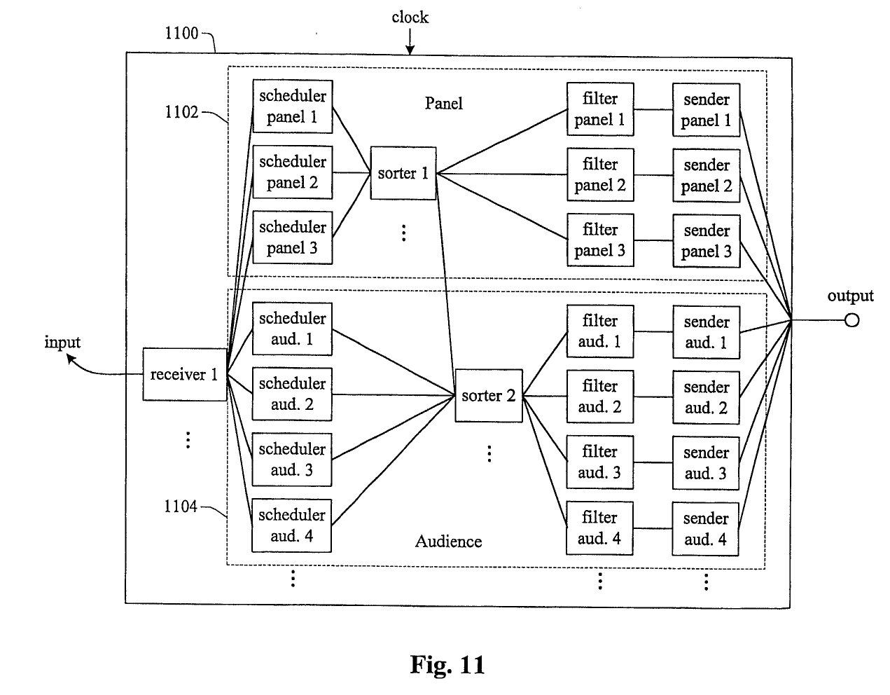

A mesh configuration 1100 for a panel discussion embodiment of the invention is shown in FIG. 11. In this embodiment, the clients are arranged in two different priority groups, the higher priority panel (indicated by dashed line 1102) and the lower priority audience (indicated by dashed line 1104). Fairness and hysteresis are implemented within each group such that, for example, the data streams for the three panel members are prioritized relative to each other in the manner described above. In this configuration, the panel members are always heard by the audience members, while the audience members will occasionally also hear other audience members.

As with the classroom embodiment described above, there is no overlap in the priority ranges of the respective groups. Sorter 1 corresponds to the panel and only receives input from the schedulers corresponding to the members of the panel. Sorter 2, which receives the data streams from all of the audience members, also receives the data streams of the panel members from the output of sorter 1 for transmission to the audience members. A single media server can handle one or multiple such panel discussions.

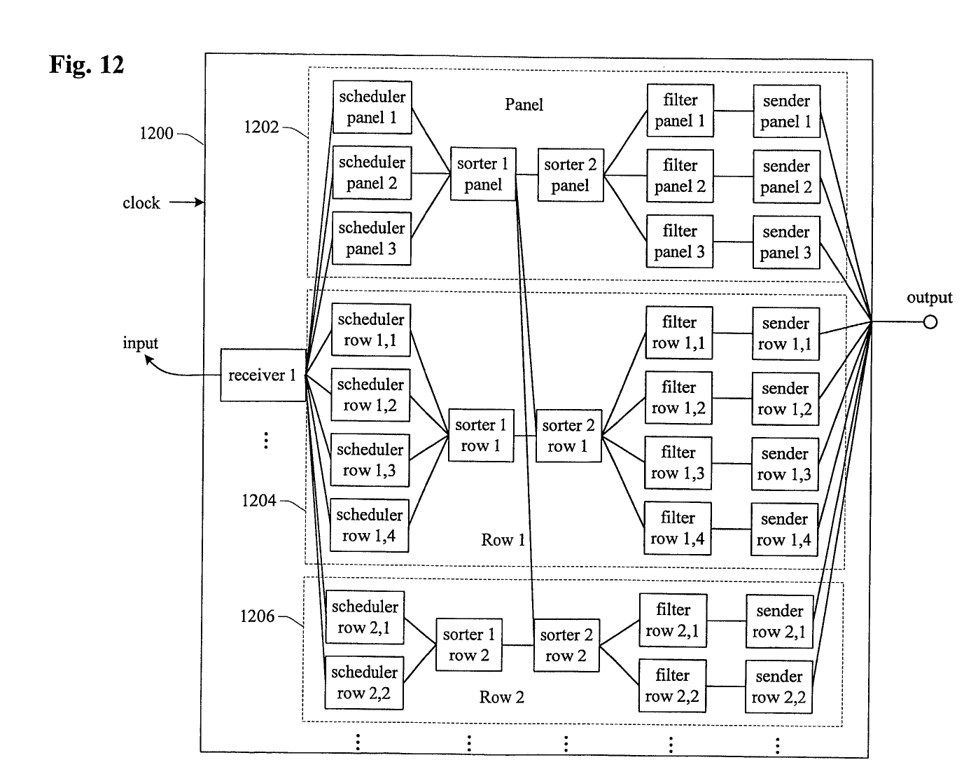

A mesh configuration 1200 for another panel discussion embodiment of the invention is shown in FIG. 12. In this embodiment, however, the audience is divided into “rows” (1204 and 1206) in which the member clients each have the same priority range, and in which a client receives only the data streams of panel 1202 and the other clients in the same row. With regard to the interaction between each individual row and the panel, the operation is similar to that described above for the audience and the panel. That is, the panel members are always heard by the clients of each row, while the clients in a particular row will occasionally also hear other clients in their row. By contrast, clients of a particular row will not hear any of the clients in other rows. A single media server can handle one or multiple such panel discussions.

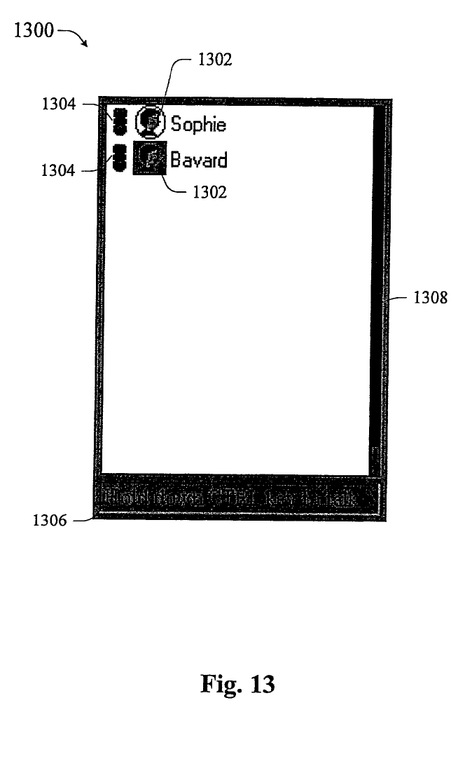

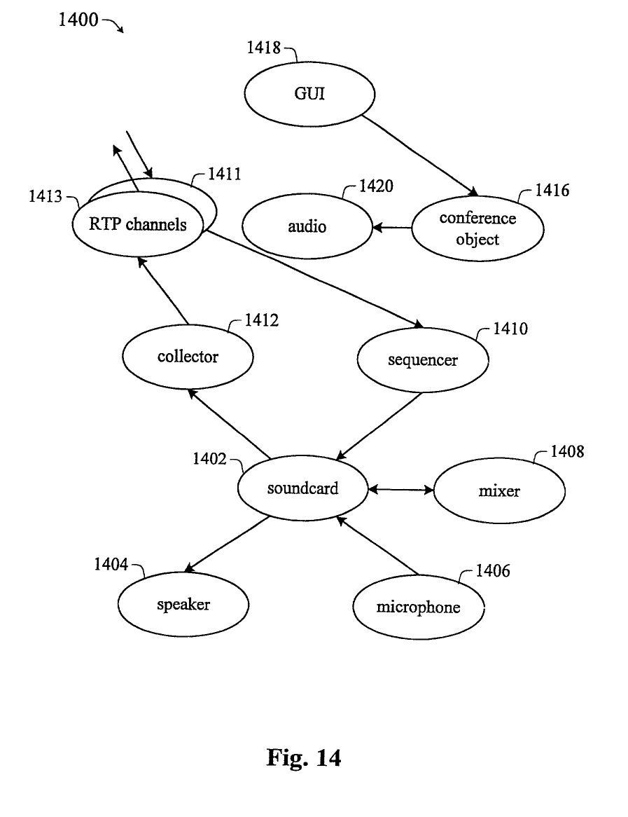

A specific embodiment of the client for use with the group conference embodiment of the invention will now be described with reference to FIGS. 13 and 14. According to a specific embodiment, the user interface 1300 is a standard Microsoft list control as shown in FIG. 13 with conference member names and associated icons 1302 listed. The client's user's icon and name are at the top of the list and the user's icon is highlighted, e.g., circled. When anybody else in the conference speaks their icon is also highlighted, e.g., background color changes, indicating that they are currently speaking.

According to one embodiment, traffic conditions are monitored for each client (e.g., by looking at dropped packets) and an indicator 1304, e.g., a traffic signal, is displayed next to their name in the list box which represents the quality of the user's connection to the server. This could be a traditional red-yellow-green traffic signal, or, alternatively, 1-3 green lights with more lights indicating a better connection. Interface 1300 includes a text message box 1306 at the bottom of the list window which displays messages such as “Hold down Ctrl key to talk” or “Server disconnected”. Up the right hand side of interface 1300 is a level meter 1308 which represents the audio level of what the user is recording when she's recording, or what the user is hearing when she's listening.

The block diagram of FIG. 14 illustrates the client architecture according to a specific embodiment of the invention. The client 1400 is either an OCX (Active X Control for Microsoft's Internet Explorer) or a DLL (i.e., a Netscape plug-in). The size of client 1400 is relatively small (<150 k for the OCX or ˜230 k for the DLL). According to various specific embodiments, both are run by the client's web browser. It will be understood, however, that because it is designed as a generic plug-in, the OCX can be embedded in other applications as well. Client 1400 is also designed to allow the customer service provider to embed code into a web page which is recognized by the client's browser as an OCX object or a DLL object.

A portion of the architecture of client 1400 is standard code for all applications which want to conform to the interfaces of Internet Explorer and Netscape Navigator. In addition, client 1400 accepts a plurality of parameters from the referring customer web page, i.e., the page through which the client gains access to the NOC. The first parameter is the server address of the server the customer wants the client to call, e.g., the dispatch server or the authentication server at the NOC. The second parameter is a user name associated with client 1400. That is, if the referring page has the user's name already, that information is passed to the conferencing system via client 1400 and the user is not asked for his name. The third parameter is the conference name which is how group membership is decided. The fourth parameter called Auto Join calls a join method in client 1400 when set to true (the default is true). The fifth parameter is an account number which is reported to the join command and which is used for verification purposes as described above.

An object class called Soundcard 1402 controls a speaker 1404 and records data from a microphone 1406. According to a specific embodiment, Soundcard 1402 is standard Windows code. An object class called Mixer 1408 goes along with Soundcard 1402 and controls the recording level and microphone input level. An object class called Sequencer 1410 is a playback item which receives packets from RTP channel 1411 and converts them for playback by Soundcard 1402 on speaker 1404. A class called Collector 1412 is a recording item which collects data from Soundcard 1402 and converts the data to packets to be sent by the upstream RTP channel 1413. A Conference object 1416 communicates with the NOC servers. Graphical user interface (GUI) 1418 is essentially a list control object as described above. An Audio object 1420 is used by Conference object 1416 to start and stop recording. As mentioned above, RTP channels 1411 and 1413 pass data downstream and upstream.

According to a specific embodiment, the control key is the mechanism used to control the microphone. That is, according to this embodiment, the client hooks the control key across the entire operating system and uses it to control the microphone. This simple but effective mechanism is easy to learn, straightforward to operate, and requires far less manual dexterity than mouse-based schemes. In addition, by defaulting the client to a “normally off” microphone state, transmit bandwidth is substantially reduced and feedback caused by loudspeakers feeding into the microphone is greatly reduced. Significantly, this mechanism works regardless of the application which is active in the foreground.

According to a specific embodiment of the invention, when a user interrupts another user by pressing her control key to talk, the stream (or run) of speech of the interrupted user to the interrupting user is terminated so that the interrupter does not have both her microphone and her speaker active at the same time. However, any new runs by other speakers are played so that the new speaker may himself be interrupted. If the new speaker lets go of the control key, any of the interrupted streams still going on will resume being played to the interrupting user. This “smart duplexing” feature avoids a speaker being interrupted by his own voice (through the interrupter's microphone). According to a specific embodiment, the filter chip corresponding to the interrupter is reconfigured in response to the interrupter pressing the control key, to ignore the data streams from any interrupted speakers, i.e., to drop the atoms corresponding to the interrupted speakers.

According to another specific embodiment of the invention, a user can double click on the names of other members of the conference to effect private instant text messaging with that client. In one embodiment, the transmission of the message is facilitated by the groups service and is effected over the TCP channel which remains open with the client proxy on the server.

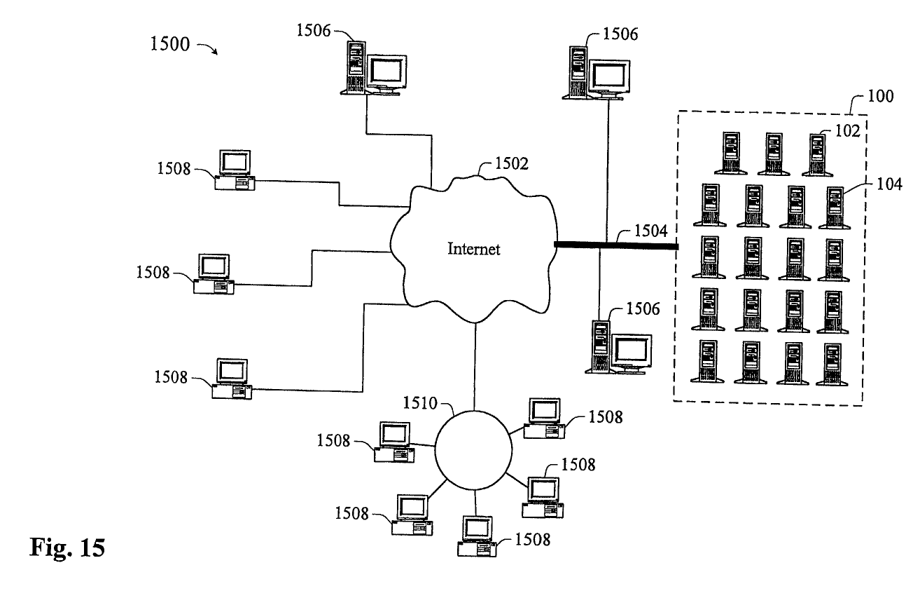

FIG. 15 is a simplified diagram of a network environment 1500 in which the present invention may be implemented. A network operating center (NOC) 100 is connected to the Internet 1502 via a high bandwidth backbone 1504. NOC 100 includes an authentication server 106, at least one dispatch server 102, and a plurality of media servers 104. Backbone 1504 may comprise, for example, a fiber optic data center such as that provided by Qwest Communications, Inc. of Denver, Colo. Internet sites 1506 through which clients 1508 may engage the services made possible by the present invention are connected to the Internet 1502 as well as directly to backbone 1504. Sites 1506 may represent, for example, web sites maintained by Internet Service Providers (ISPs). Clients may be directly connected to the Internet as shown, or, for example, via a local or wide area network 1510.

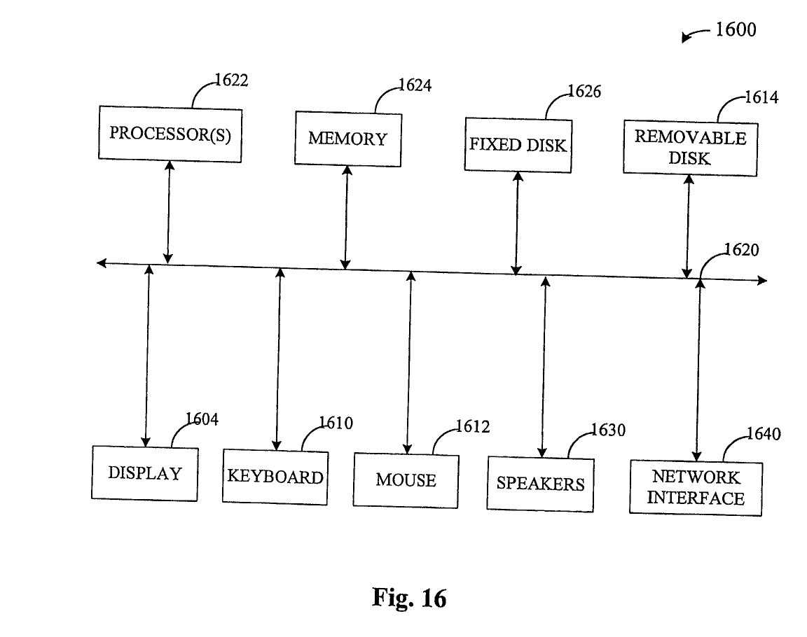

FIG. 16 is a block diagram of a generalized computer system 1600 which may be used to implement the various servers and clients described herein. Attached to system bus 1620 are a wide variety of subsystems. Processor(s) 1622 (also referred to as central processing units, or CPUs) are coupled to storage devices including memory 1624. Memory 1624 includes random access memory (RAM) and read-only memory (ROM). As is well known in the art, ROM acts to transfer data and instructions uni-directionally to the CPU and RAM is used typically to transfer data and instructions in a bi-directionally manner. Both of these types of memories may include any suitable ones of the computer-readable media described below. A fixed disk 1626 is also coupled bi-directionally to CPU 1622; it provides additional data storage capacity and may also include any of the computer-readable media described below. Fixed disk 1626 may be used to store programs, data and the like and is typically a secondary storage medium (such as a hard disk) that is slower than primary storage. It will be appreciated that the information retained within fixed disk 1626, may, in appropriate cases, be incorporated in standard fashion as virtual memory in memory 1624. Removable disk 1614 may take the form of any of the computer-readable media described below.

CPU 1622 may also be coupled to a variety of input/output devices such as display 1604, keyboard 1610, mouse 1612 and speakers 1630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1622 optionally may be coupled to another computer or telecommunications network using network interface 1640. With such a network interface, it is contemplated that the CPU might receive information from the network, or might output information to the network in the course of performing the above-described method steps. Furthermore, method embodiments of the present invention may execute solely upon CPU 1622 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described with reference to the object oriented Java programming language and development tools. It will be understood, however, that the principles of the present invention may be embodied using a variety of other software paradigms including, for example, other object oriented programming languages and tools. Moreover, merely because specific embodiments of the invention have been described with reference to communications over the Internet and/or the World Wide Web does not restrict the scope of the invention to such implementations. On the contrary, the scope of the invention encompasses a much broader interpretation of network environments including, for example, local area and wide area networks. Therefore, the scope of the invention should be determined with reference to the appended claims.

What is claimed is:

1. A method for facilitating communication between a plurality of clients on a network, comprising:
receiving a request with a dispatch server, the request being from a first one of the plurality of clients to join a first conference; and
statelessly dispatching the first client to the first conference on a first one of a plurality of media servers associated with the dispatch server.

2. The method of claim 1 further comprising determining whether the first conference is currently being facilitated on any of the media servers.

3. The method of claim 2 wherein determining whether the first conference is currently being facilitated on any of the media servers comprises polling the media servers and receiving a response from the first media server.

4. The method of claim 2 further comprising triggering creation of the first conference on the first media server where the first conference is not currently being facilitated on any of the media servers.

5. The method of claim 4 further comprising determining which of the plurality of media servers has the most available capacity for creation of the first conference and receiving a response from the first media server.

6. The method of claim 5 wherein determining which of the plurality of media servers has the most available capacity is done with reference to a media type associated with the first conference.

7. The method of claim 5 wherein determining which of the plurality of media servers has the most available capacity is done with reference to a number of users associated with the first conference.

8. The method of claim 1 further comprising:
receiving an initial request with an authentication server, the initial request being from the first client to join the first conference;
validating the initial request; and
dispatching the first client to the dispatch server.

9. The method of claim 8 wherein validating the initial request comprises validating an authentication code associated with the initial request.

10. The method of claim 9 wherein the first client obtains the authentication code from a referring host.

11. The method of claim 8 wherein validating the initial request is done with reference to a communication from a referring host alerting the first media server that the first client will be transmitting a subsequent request to the first media server.

12. The method of claim 1 further comprising maintaining a list of the media servers in a memory associated with the dispatch server.

13. The method of claim 12 wherein maintaining the list comprises adding a particular media server to the list when the particular media server registers with the dispatch server.

14. The method of claim 1 further comprising alerting the first media server that the first client will be transmitting a subsequent request to the first media server.

15. The method of claim 14 wherein alerting the first media server comprises causing an entry corresponding to the first client to be entered in a will call list associated with the first media server.

16. The method of claim 1 further comprising monitoring a signal indicative of an operational status of the dispatch server.

17. The method of claim 16 wherein monitoring the signal comprises establishing direct communication between the dispatch and standby servers.

18. The method of claim 16 further comprising replacing the dispatch server with a standby server where the operational status of the dispatch server indicates a failure.

19. The method of claim 18 wherein replacing the dispatch server with the standby server comprises disconnecting the dispatch server from the network and allowing the standby server to take over the IP address of the dispatch server.

20. The method of claim 1 wherein dispatching the first client to the first conference on the first media server comprises transmitting an IP address associated with the first media server to the first client.

21. The method of claim 1 further comprising transmitting information regarding other participants in the first conference to the first client.

22. The method of claim 21 wherein transmitting information comprises adding a user to a user interface associated with the first client when a second client joins the first conference.

23. The method of claim 22 wherein transmitting information further comprises deleting the user from the user interface when the second client leaves the first conference.

24. The method of claim 1 further comprising where an event associated with the first media server occurs, dynamically recreating the first conference on a second media server.

25. The method of claim 24 wherein dynamically recreating the first conference comprises statelessly dispatching each participant in the first conference to the second media server.

26. The method of claim 24 wherein the event comprises a failure of the first media server.

27. The method of claim 24 wherein the event relates to a capacity of the first media server.

28. The method of claim 1 further comprising monitoring latency data relating to the first conference.

29. The method of claim 28 further comprising adjusting a capacity associated with the first media server in response to the latency data.

30. A system for facilitating communication between a plurality of clients on a network, comprising:
a plurality of media servers coupled to the network, each media server being for facilitating at least one conference, each of the conferences corresponding to a subset of the plurality of clients; and
a dispatch server coupled to the network for statelessly dispatching the clients to the conferences on the media servers, the dispatch server being operable in response to a request from a first one of the clients to join a first conference to do one of determine which of the media servers is facilitating the first conference, and trigger creation of the first conference on a first one of the media servers where the first conference is not currently being facilitated.

31. The system of claim 30 further comprising an authentication server for receiving an initial request from the first client to join the first conference, validating the initial request, and dispatching the first client to the dispatch server.

32. The system of claim 30 further comprising a standby server for replacing the dispatch server where an operational status of the dispatch server indicates a failure.

33. The system of claim 32 further comprising a local area network connecting the standby and dispatch servers for communicating the operational status.

34. A dispatch server for facilitating communication between a plurality of clients on a network using a plurality of media servers on the network, comprising:
a server object;
a remote server service running on the server object for providing access to the server object; and
a master service running on the server object for communicating with and managing operation of the media servers in a stateless manner, the master service also being for statelessly dispatching the plurality of clients to conferences on the media servers.

35. The dispatch server of claim 34 further comprising a client host service running on the server object for facilitating connection of the plurality of clients with the dispatch server.

36. The dispatch server of claim 34 further comprising a slave service for communicating with the master service.

37. A media server for facilitating communication between a plurality of clients on a network in conjunction with a dispatch server on the network, comprising:
a server object;
a remote server service running on the server object for providing access to the server object;
a slave service running on the server object for communicating with the dispatch server;
a mesh service running on the server object for dynamically providing virtual connections among the plurality of clients for transmission of data and thereby facilitating a conference including the plurality of clients, the virtual connections being dynamically created using a plurality of connection objects; and
a connect service running on the server object for configuring the connection objects in the mesh service to provide the virtual connections.

38. The media server of claim 37 further comprising a client host service running on the server object for facilitating connection of the plurality of clients with the media server.

39. A method for facilitating a first conference between a plurality of clients on a network, comprising:
receiving a request to join a first conference from a first one of the plurality of clients via the network;
in response to the request, determining whether the first conference is currently being facilitated on any of a plurality of media servers;
where the first conference is currently being facilitated on a first one of the plurality of media servers, statelessly dispatching the first client to the first conference on the first media server; and
where the first conference is not currently being facilitated on any of the plurality of media servers, triggering creation of the first conference on a second one of the plurality of media servers and statelessly dispatching the first client to the first conference on the second media server.

40. A mesh service for running on a server object on a media server, the media server for facilitating a plurality of conferences among a plurality of clients, the mesh service for dynamically providing virtual connections among the plurality of clients and thereby facilitating the conferences, the mesh service comprising:
a receiver object for each type of media handled by the mesh service, the receiver object being operable to receive first data packets from each of the plurality of clients, and convert the first data packets to data units;
a plurality of scheduler objects coupled to the receiver object, each of the scheduler objects being associated with one of the plurality of clients, each scheduler object being operable to receive the data units from the receiver object, select first data units corresponding to the associated client from among the data units, and schedule when the first data units should be transmitted;
a plurality of sorter objects coupled to the scheduler objects, each of the sorter objects being associated with one of the conferences, each sorter object being operable to receive the first data units from selected ones of the scheduler objects associated with the associated conference, and organize the first data units according to priorities;
a plurality of filter objects coupled to sorter objects, each of the filter objects being associated with one of the plurality of clients, each filter object being operable to receive the first data units from each of the sorter objects, and select second data units from among the first data units, the second data units excluding any of the first data units corresponding to the associated client; and
a plurality of sender objects coupled to the filter objects, each of the sender objects being associated with one of the plurality of clients, each sender object being operable to receive the second data units from one of the filter objects which corresponds to the associated client, convert the second data units into second data packets, and transmit the second data packets to the associated client.

41. The mesh service of claim 40 wherein the receiver, scheduler, sorter, filter and sender objects are derived from a common connection object comprising an input method for subscribing to an output of a first connection object and receiving data units therefrom, an output method for transmitting the data units to a second connection object subscribing to the output method, and a clock method for moving the data units from the input method to the output method.

42. A mesh service for running on a media server, the media server for facilitating communication among a plurality of clients, the mesh service comprising:
a receiver object for receiving first data packets and converting the first data packets to data units;
a scheduler object for receiving the data units, selecting first data units corresponding to an associated client from among the data units, and scheduling when the first data units should be transmitted;
a sorter object for receiving the first data units, and organizing the first data units according to priorities;
a filter object for receiving the first data units, and selecting second data units from among the first data units, the second data units excluding any of the first data units corresponding to an associated client; and
a sender object for receiving the second data units, converting the second data units into second data packets, and transmitting the second data packets to an associated client;
wherein the receiver, scheduler, sorter, filter, and sender objects are each derived from a common connection object and are dynamically configured to provide virtual connections among the plurality of clients.

43. A mesh service for running on a media server, the media server for facilitating communication among a plurality of clients, the mesh service comprising:
a receiver object for receiving first data packets and converting the first data packets to data units;
a scheduler object for receiving the data units, selecting first data units corresponding to an associated client from among the data units, and scheduling when the first data units should be transmitted; and
a sender object for receiving the first data units, converting the first data units into second data packets, and transmitting the second data packets to an associated client;
wherein the receiver, scheduler, and sender objects are each derived from a common connection object and are dynamically configured to provide virtual connections among the plurality of clients.

44. A mesh service for running on a media server, the media server for facilitating communication among a plurality of clients, the mesh service comprising a plurality of instances of a connection object class comprising an input method for subscribing to an output of a first connection object and receiving data units therefrom, an output method for transmitting the data units to a second connection object subscribing to the output method, and a clock method for moving the data units from the input method to the output method, wherein the plurality of instances of the connection object class are dynamically configured to provide virtual connections among the plurality of clients.

45. A method for facilitating communication among a plurality of clients on a media server, comprising dynamically configuring a plurality of instances of a connection object to provide virtual connections among the plurality of clients, the connection object class comprising an input method for subscribing to an output of a first connection object and receiving data units therefrom, an output method for transmitting the data units to a second connection object subscribing to the output method, and a clock method for moving the data units from the input method to the output method.

46. The method of claim 45 wherein the plurality of instances of the connection object class comprises a receiver object for receiving first data packets and converting the first data packets to data units, a plurality of scheduler objects for selecting first data units corresponding to an associated client from among the data units, and scheduling when the first data units should be transmitted, and a plurality of sender objects for receiving the scheduled first data units, converting the selected first data units into second data packets, and transmitting the second data packets to an associated client, and wherein dynamically configuring the plurality of instances comprises coupling the receiver object to the scheduler objects and coupling the scheduler objects to the sender objects.

47. The method of claim 46 wherein the plurality of instances of the connection object class further comprises a plurality of sorter objects for organizing the first data units according to priorities, each of the sorter objects corresponding to an associated conference, the connection object class further comprising a plurality of filter objects for excluding any of the first data units corresponding to an associated client thereby resulting in the selected first data units, and wherein coupling the scheduler objects to the sender objects is done using the sorter and filter objects.

48. A method for facilitating a first conference on a network between a first client and at least one other client, comprising:
transmitting a first request to join the first conference to a dispatch server via the network;
receiving a dispatch command from the dispatch server, the dispatch command identifying a first one of a plurality of media servers;
transmitting a second request to join the first conference to the first media server in response to the dispatch command from the dispatch server; and
establishing a connection with the first media server by which the first client may participate in the first conference.

49. A computer program product for facilitating a first conference on a network between a first client and at least one other client, comprising:
at least one computer readable medium;
computer program instructions embedded in the at least one computer readable medium for causing a computer to:
transmit a first request to join the first conference to a dispatch server via the network;
receive a dispatch command from the dispatch server, the dispatch command identifying a first one of a plurality of media servers;
transmit a second request to join the first conference to the first media server in response to a dispatch command from the dispatch server; and
establish a connection with the first media server by which the first client may participate in the first conference.

50. The computer program product of claim 49 wherein the computer program instructions comprise a browser plug-in.

51. The computer program product of claim 50 wherein the browser plug-in comprises a DLL.

52. The computer program product of claim 50 wherein the browser plug-in comprises an OCX.

53. A method for transmitting the computer program instructions of claim 49, comprising:
storing the computer program instructions onto a computer-usable medium;
receiving a request for transmission of the computer program instructions; and
transmitting the computer program instructions over a network to a remote location.

54. A computer data signal embodied in a carrier wave and representing program instructions which, when executed by a processor, cause the processor to facilitate a first conference on a network between a first client and at least one other client by:
transmitting a first request to join the first conference to a dispatch server via the network;
receiving a dispatch command from the dispatch server, the dispatch command identifying a first one of a plurality of media servers;
transmitting a second request to join the first conference to the first media server in response to a dispatch command from the dispatch server; and
establishing a connection with the first media server by which the first client may participate in the first conference.

55. A method for facilitating a first conference on a network between a first client and at least one other client, comprising:
transmitting a graphical user interface to the first client via the network, the graphical user interface including an object corresponding to the first conference; and
transmitting first data to the first client via the network, the first data identifying a remote conferencing system, the remote conferencing system including a plurality of media servers coupled to the network, and a dispatch server coupled to the network for statelessly dispatching the first client to the first conference on one of the media servers, the dispatch server being operable in response to a request from the first client to join the first conference to do one of determine which of the media servers is facilitating the first conference, and create the first conference on a first one of the media servers where the first conference is not currently being facilitated.
